(19) United States
(12) Patent Application Publication
(10) Pub. No.: US 2006/0188354 A1
(43) Pub. Date: Aug. 24, 2006

(54) Cargo restraint apparatus

(76) Inventor: James M. Bosley, Edmond, OK (US)

Correspondence Address: DUNLAP, CODDING & ROGERS P.C., PO BOX 16370, OKLAHOMA CITY, OK, 73113, US

(21) Appl. No.: 11/361,867

(22) Filed: Feb. 24, 2006

Related U.S. Application Data
(60) Provisional application No. 60/656,008, filed on Feb. 24, 2005.

(51) Int. Cl. B60P 3/06

(52) U.S. Cl. 410/23; 410/103

(57) ABSTRACT

A cargo restraint apparatus restrains the movement of a cargo of a vehicle. The apparatus includes a frame assembly, a spool, an elongated strap, a biasing member, a locking mechanism, and an adjustment apparatus. The frame assembly is connected to the vehicle. The spool is rotatably mounted on the frame assembly. The elongated strap has a first end connected to the spool and a second end attached to the vehicle with the elongated strap positioned over the cargo. The elongated strap is adapted to be wound about and withdrawn from the spool. The biasing member biases the spool in a strap winding position. The locking mechanism locks the spool at a selected position to prevent withdrawal of the elongated strap from the spool. The adjustment apparatus is attached to the elongated strap for cinching the elongated strap into a taut condition to restrain movement of the cargo.

### CROSS-REFERENCE TO RELATED APPLICATIONS

This application claims the benefit under 35 U.S.C. 119(e) of U.S. Provisional Application Ser. No. 60/656,008, filed Feb. 24, 2005, the contents of which are hereby expressly incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to a cargo restraint apparatus for securing cargo, and more particularly, but not by way of limitation, to an improved cargo restraint apparatus having a locking mechanism.

2. Brief Description of the Related Art

Straps, belts, ropes, cables, and other devices have generally been used to secure a cargo to a vehicle. The conventional practice has been to employ tie-down straps or elastic cords having a hook at each end to secure the cargo to a variety of vehicles, such as a truck bed, a golf cart, or a sport-utility-vehicle (“SUV”) cargo compartment. Other securing devices, such as seat belts, employ a retractable strap apparatus with an elongated strap positionable about individuals in the vehicle.

One type of retractable strap apparatus employed as a seat belt and adapted to be used as a cargo restraint is known as an emergency locking retractor (ELR). The ELR is constructed to allow the elongated strap to freely extend or rewind. The ELR locks only in response to vehicle motion or when the elongated strap is pulled quickly. After the tension is released, the elongated strap can again be pulled out gradually.

To this end, a need exists for a cargo restraint apparatus for use with a vehicle that permits the cargo to be efficiently and effectively secured. It is to such a cargo restraint apparatus that the present invention is directed.

### BRIEF DESCRIPTION OF THE SEVERAL VIEWS OF THE DRAWING

FIG. 1 is a top plan view of a truck bed carrying a cargo which is secured in position by a pair of cargo restraint apparatuses constructed in accordance with the present invention.

FIG. 2 is a perspective representation of a cargo restraint apparatus shown constructed in accordance with the present invention in an extended position.

FIG. 3 is a top plan view of the cargo restraint apparatus of FIG. 2.

FIG. 4 is a perspective view of the principal portion of an automatic locking retractor.

FIG. 5 is a cross-sectional view of the retractor of FIG. 4.

FIG. 6 is a partial cross-sectional perspective view of another embodiment of a cargo restraint apparatus.

### DETAILED DESCRIPTION OF THE INVENTION

Before explaining at least one embodiment of the invention in detail, it is to be understood that the invention is not limited in its application to the details of construction, experiments, exemplary data, and/or the arrangement of the components set forth in the following description or illustrated in the drawings. The invention is capable of other embodiments or of being practiced or carried out in various ways. Also, it is to be understood that the phraseology and terminology employed herein is for purpose of description and should not be regarded as limiting.

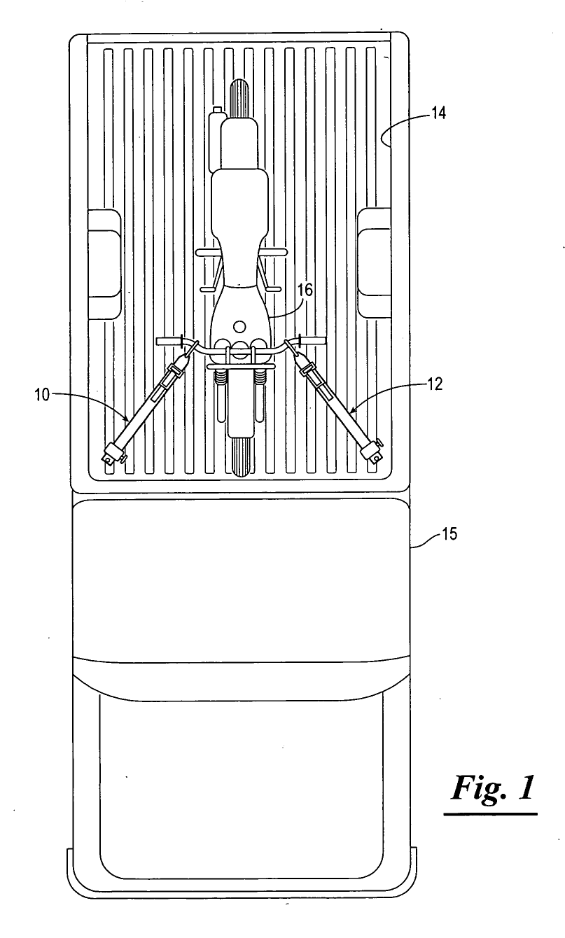

Referring now to the drawings, and more particularly to FIG. 1, a pair of cargo restraint apparatuses 10 and 12 constructed in accordance with the present invention is shown employed in a truck bed 14 of a vehicle 15 to support a motorcycle 16 in an upright position. It should be understood that though a truck bed 14 is shown supporting the motorcycle 16, any suitable mounting surface or any suitable mounting surface of a vehicle, including a trailer, may be used to secure and transport the motorcycle 16. In addition, though a motorcycle 16 is shown as the object being transported by the vehicle 15, it should be understood that the cargo restraint apparatus 10 is not limited to use with a vehicle, but may be used to secure cargo, loads, or other equipment to other structures, such as shelving, all-terrain vehicles (ATV's), and lumber, for example, in accordance with the present invention.

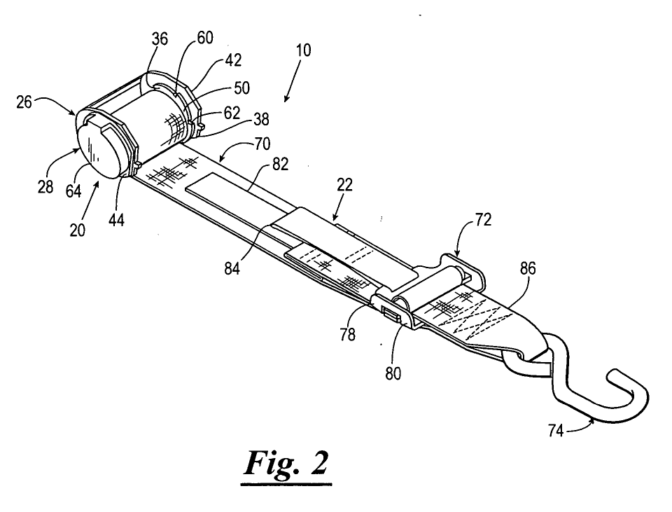

Referring now to FIGS. 2-5, the cargo restraint apparatus 10 includes a retractor assembly 20 and a strap assembly 22. The retractor assembly 20 includes a frame assembly 26, a biasing assembly 28, and a locking mechanism 30. The retractor assembly 20 is housed in a housing 31. The housing 31 may be constructed from plastic, metal, or any other such material.

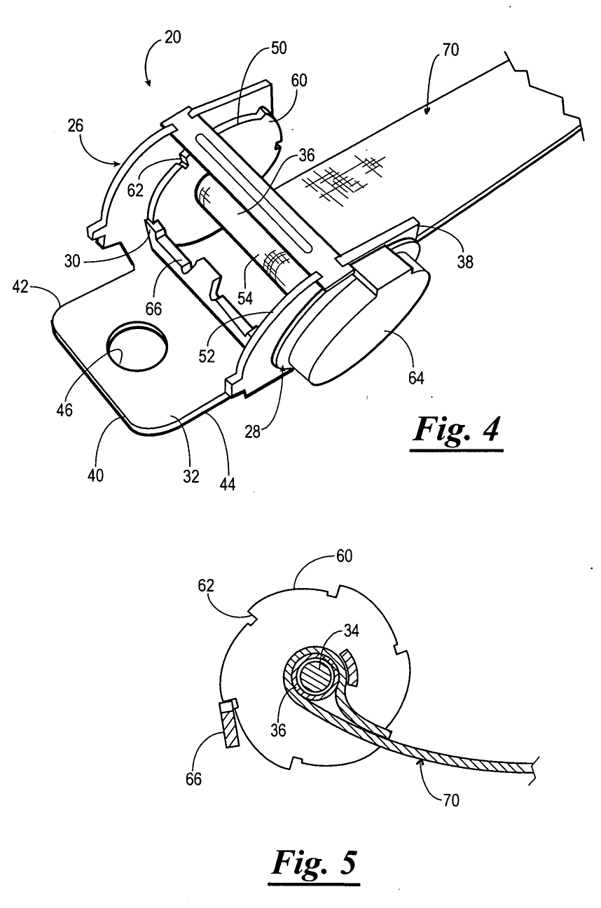

The retractor assembly 20 may be any commercially available automatic locking retractor, commonly known in the art as an ALR, an example as shown in FIG. 4. The ALR is well-known in the field of seat belt safety, thus no further description is believed necessary to enable one of ordinary skill in the art to make an ALR. A suitable retractor assembly 20 for the cargo restraint apparatus 10 is commercially available from such manufacturers as, for example, TRW Automotive, Autoliv Inc., or Key Safety Systems, Inc. However, it should be understood by one of ordinary skill in the art that other automatic retractor assemblies may be used in accordance with the present invention. The ALR is constructed so that the strap assembly 22 is allowed to be extended out initially, but is locked when the extension action stops and tension is again applied.

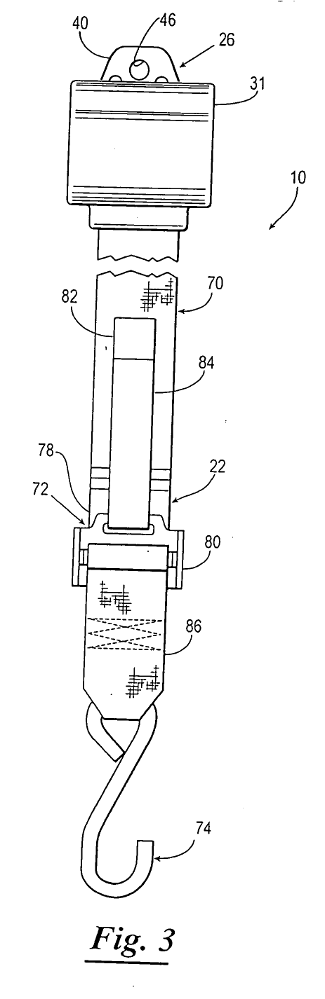

The frame assembly 26 includes a frame 32, a shaft 34, and a spool 36. The frame 32 has a front end 38, a rear end 40, a first side 42, and a second side 44. As shown in FIG. 3, the rear end 40 of the frame 32 is provided with an opening 46 which allows the frame 32 of the frame assembly 26 to be mounted to a vehicle permanently by a threaded nut and bolt arrangement (not shown) or to be mounted with a snap hook 47 allowing for a quick connection and disconnection of the frame assembly 26 from a portion of the vehicle or other support member. It should be understood that any suitable attachment of the frame 32 to the vehicle may be used. The frame 32 is preferably constructed from stainless steel, but may also be constructed from a polymeric material or another suitable, rigid material.

Referring now to FIG. 5, the shaft 34 of the frame assembly 26 has a first end (not shown), a second end (not shown), and an elongated opening (not shown) extending therebetween. The shaft 34 may be constructed from any rigid, durable material, such as steel, or a polymer, such as polyethylene or polypropylene. The shaft 34 is positioned between the front end 38 and the rear end 40 of the frame 32.

Referring to FIGS. 2-5, the spool 36 of the frame assembly 26 has a first end 50, a second end 52, and an elongated tubular hub portion 54 extending therebetween. The spool 36 is positioned between the first side 42 and the second side 44 of the frame 32 so as to be rotatably mounted on the shaft 34. Each end 50 and 52 of the spool 36 has a ratchet 60 having teeth 62 formed on an outer periphery thereof.

The biasing assembly 28 includes a spring (not shown), and a spring cover 64. The spring is operably connected to the shaft 34 so that it rotates in the same direction as the shaft 34 is moved. The spring is positioned in a coiled, stored position.

The locking mechanism 30 includes a pawl 66 hinged on the first and second sides 42 and 44 of the frame 32. The locking mechanism 30 of the retractor assembly 20 permits retraction of the strap assembly 22 even when the retractor assembly 20 is in a locked condition. In the locked condition, the pawl 66 of the locking mechanism 30 engages teeth 62 of the ratchet 60 of the spool 36 of the retractor assembly 20 preventing the strap assembly 22 from being withdrawn.

The strap assembly 22 includes an elongated strap 70, a strap tensioning assembly 72, and a fastener 74. The elongated strap 70 may be composed of any natural or synthetic material strong enough to be used in the present invention. The elongated strap 70 has a first end 76 and a second end 78. A portion of the first end 76 of the elongated strap 70 is operably connected to the spool 36 of the retractor assembly 20. The elongated strap 70 is adapted to be wound about and withdrawn from the spool 36 of the retractor assembly 20. Once the webbing is rewound, it cannot be pulled out any longer. The elongated strap 70 of the strap assembly 22 is unspooled a distance before the point of first lock. Preferably, in one embodiment, so as to not be limiting, eighteen-twenty-two (18-22) inches of webbing is initially pulled out from the spool 36 of the retractor assembly 22 before the retractor assembly 22 will lock. However, it should be understood to one of ordinary skill in the art that the length of webbing initially pulled out from the spool may vary depending on how the webbing is positioned on the spool.

As shown in FIGS. 2-3, the strap tensioning assembly 72 has a buckle or inline adjuster 80 slidingly attached to the elongated strap 70. The buckle 80 may also be an over-center buckle or other such buckle commonly used with straps to produce a relatively high tension to prevent cargo from shifting. A portion of the second end 78 of the elongated strap 70 is provided with a first handle 82 to facilitate tightening of the elongated strap 70 about a load. The buckle 80 is also provided with a second handle 84 to loosen the elongated strap 70 from about the load. An extension strap 86 is attached to the buckle 80 and is attached to the fastener 74 for attaching the elongated strap 70 to an object, vehicle 15, or load. The fastener 74 is shown to be a hook with a general S-configuration. However, any such fastener may be used such as a snap link, clip, or the like to attach the retractor assembly 20 to an existing anchor point.

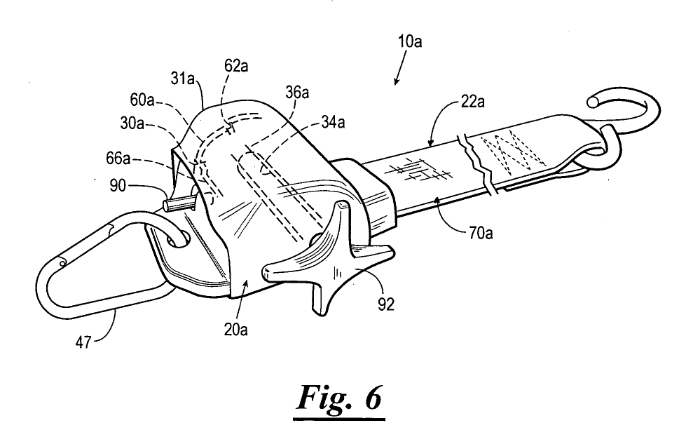

Referring to FIG. 6, another embodiment of a cargo restraint apparatus 10a is shown. The cargo restraint apparatus 10a is substantially similar to the cargo restraint apparatus 10. That is, the cargo restraint apparatus 10a includes a retractor assembly 20a and a strap assembly 22a substantially similar to the retractor assembly 20 and the strap assembly 22. A pawl 66a of a locking mechanism 30 of the retractor assembly 20a has a lever 90 extending from a housing 31a. The lever 90 enables the pawl 66a of the locking mechanism 30a to be manually pivoted between a locking position and an unlocking position. In the locking position, the pawl 66a of the locking mechanism 30a engages teeth 62a of the ratchet (wheel) 60a of a spool 36a of the retractor assembly 20a preventing an elongated strap 70a of the strap assembly 22a from being withdrawn. In the unlocking position, the lever 90 manually disengages the pawl 66a from the teeth 62a of the ratchet 60a so that the elongated strap 70a of the strap assembly 22a may be retracted into the retractor assembly 20a and the housing 31a.

Further, an outer biasing member 92 is connected to a shaft 34a of the retractor assembly 20a. The outer biasing member 92 may be a knob, switch, dial, handle, or the like. The outer biasing member 92 enables a user to manually retract the elongated strap 70a of the strap assembly 22a so as to tighten the strap assembly 22 thereby further securing the cargo to the vehicle 15. The outer biasing member 92 may be manual or automatic.

In use, the retractor assembly 20 is connected to the vehicle 15. The elongated strap 70 is withdrawn from the retractor assembly 20 and positioned about the cargo. The locking mechanism 30 of the retractor assembly 20 keeps the elongated strap 70 of the strap assembly 22 from being pulled out farther until the elongated strap 70 is fully retracted. Thus, if the elongated strap 70 of the strap assembly 22 is retracted slightly after having been extended out to an arbitrary length, further withdrawal of the elongated strap 70 is automatically prevented. The locking mechanism 30 of the retractor assembly 20 acts as a ratchet, winding in slack and preventing further extension of the elongated strap 70. This action of the retractor assembly 20 maintains cargo in a secured position during transportation because the retractor assembly 20 only allows for tightening of the elongated strap 70 of the strap assembly 22 about the cargo, thereby, decreasing damage to the cargo as well as injury to an individual unloading or loading cargo. The fastener 74 of the strap assembly 22 is then attached to the cargo or the vehicle 15. The elongated strap 70 is tightened about the load with the first handle 82.

To remove the elongated strap 70 from the cargo, the second handle 84 is grasped and pulled sharply in a direction generally away from the retractor assembly 20, thus releasing the tension on and creating slack in the elongated strap 70. The slack in the elongated strap 70 allows the fastener 74 to be unattached from the cargo or the vehicle 15.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A cargo restraint apparatus in combination with a vehicle for restraining the movement of a cargo of the vehicle, the apparatus comprising:
a frame assembly connected to the vehicle;
a spool rotatably mounted on the frame assembly;
an elongated strap having a first end and a second end, the first end of the elongated strap connected to the spool and the second end of the elongated strap attached to the vehicle with the elongated strap positioned over the cargo, the elongated strap adapted to be wound about and withdrawn from the spool;
a biasing member for biasing the spool in a strap winding position;
a locking mechanism for locking the spool at a selected position to prevent withdrawal of the elongated strap from the spool; and
an adjustment apparatus attached to the elongated strap for cinching the elongated strap into a taut condition to restrain movement of the cargo.

2. The cargo restraint apparatus of claim 1 wherein the adjustment apparatus comprises:
a buckle slidably connected to the second end of the elongated strap; and
an extension strap having one end connected to the buckle and another end connected to the vehicle.

3. The cargo restraint apparatus of claim 2 wherein the adjustment apparatus further comprises a hook attached to the extension strap for connecting the extension strap to the vehicle.

4. The cargo restraint apparatus of claim 1 further comprising:
an outer biasing member operably connected to the spool for manually retracting the elongated strap so as to tighten the elongated strap thereby further securing the cargo to the vehicle.

5. The cargo restraint apparatus of claim 1 further comprising:
a lever operably connected to the locking mechanism, the lever manually unlocking the spool so that the elongated strap is withdrawn from the spool.

6. A cargo restraint apparatus, comprising:
a frame assembly connectable to a support surface;
a spool rotatably mounted on the frame assembly;
an elongated strap having a first end and a second end, the first end of the elongated strap connected to the spool and the second end of the elongated strap attachable to the support surface with the elongated strap positioned over a cargo in a vehicle, the elongated strap adapted to be wound and withdrawn from the spool;
a biasing member for biasing the spool in a strap winding position;
a locking mechanism for locking the spool at a selected position to prevent withdrawal of the elongated strap from the spool; and
an adjustment apparatus attached to the elongated strap for cinching the elongated strap into a taut condition to restrain movement of the cargo in the vehicle.

7. The cargo restraint apparatus of claim 4 wherein the adjustment means comprises:
a buckle slidably connected to the second end of the elongated strap; and
an extension strap having one end connected to the buckle and another end connected to the support surface.

8. The apparatus of claim 7 wherein the adjustment means further comprises a hook attached to the extension strap for connecting the extension strap to the support surface.

9. A method of restraining the movement of cargo in a vehicle, the method comprising:
connecting a frame assembly to the vehicle;
withdrawing an elongated strap from a spool rotatably mounted on the frame assembly, one end of the elongated strap being connected to the spool;
positioning the elongated strap about the cargo;
attaching the elongated strap to the vehicle; and
cinching the elongated strap into a taut condition when the spool is locked to restrain movement of the cargo.

10. The method of claim 9 further comprising:
manually retracting the elongated strap with a handle so as to tighten the elongated strap thereby further securing the cargo to the vehicle.
